(19) United States
(12) Patent Application Publication
(10) Pub. No.: US 2026/0265860 A1
(43) Pub. Date: Sep. 10, 2026

(54) RECYCLING OF CATALYST COATED MEMBRANES

(71) Applicant: BASF CATALYSTS GERMANY GMBH, Hannover (DE)

(72) Inventors: Wolfgang ROHDE, Ludwigshafen am Rhein (DE); Andreas HAAS, Ludwigshafen am Rhein (DE); Gareth Combemere SMITH, Seneca, SC (US); Oliver GRONWALD, Ludwigshafen am Rhein (DE); Oliver PIKHARD, Ludwigshafen am Rhein (DE)

(21) Appl. No.: 19/491,280

(22) PCT Filed: Jun. 25, 2024
(86) PCT No.: PCT/EP2024/067740

§ 371 Date: Dec. 8, 2025

(30) Foreign Application Priority Data
Jun. 26, 2023 (EP) 23181510.1

(51) Int. Cl. C22B 7/00; C22B 11/00

(52) U.S. Cl. CPC C22B 7/009; C22B 7/007; C22B 11/048

(57) ABSTRACT

A recycling process for recovering a metal from a catalyst coated membrane comprising a fluorocarbon-containing ionomer membrane and at least one catalyst coating comprising the metal. A process for preparing a catalyst coated membrane from the metal recovered according to the recycling process of the present invention.

The present invention relates to a recycling process for recovering a metal from a catalyst coated membrane comprising a fluorocarbon-containing ionomer membrane and a catalytic coating comprising the metal and a unit for carrying out said process. The present invention further relates to a process for preparing a catalyst coated membrane from the metal recovered according to the recycling process of the present invention.

Catalyst coated membranes (CCM) are generally composed of perfluorosulfonicacid (PFSA) polymer and platinum group metal catalyst particles coated on a PFSA membrane with a PFSA binder. Both platinum group metal catalyst and the PFSA polymers are valuable components that should be recycled in an efficient way. In this regard, it has been described in the art how to separate either the coating containing the platinum group metal from the membrane or how to directly leach the platinum group metal from the membrane by oxidizing acidic media.

There are many examples in the literature describing the leaching of platinum group metals from such catalyst coated membranes, namely in WO 2006/073840 A1 and WO 2010/132156 A1. There are also several examples in the literature describing the delamination of the catalyst coating from the catalyst coated membranes by treatment with organic solvents, namely in WO 2015/010793 A2, WO 2016/156815 A1 and EP 2 036 153 B1.

Some examples of combining these steps in the sequence: firstly detachment of the catalyst coating by organic solvents and secondly leaching of the platinum group metals are given in EP3000902 B1 and EP3957759 A1. However, there is a need to provide recycling processes which permits to recover the platinum group in better yield and also the other components of the catalyst coated membranes, such as the polymers.

Surprisingly, it was found that the processes of the present invention permit to increase significantly the recovery of the metal, in particular platinum group metal such as platinum, in the catalyst coated membranes and to recover the polymer present in the catalyst coating onto the membrane.

Therefore, the present invention relates to a recycling process for recovering a metal from a catalyst coated membrane comprising a fluorocarbon-containing ionomer membrane and a catalytic coating comprising a polymer and the metal, said metal being selected from the group consisting of platinum group metals, gold, silver, copper, nickel, cobalt, rare earth metals, gallium, indium, germanium, alloys of two or more thereof and mixtures of two or more thereof, the process comprising
(i) providing the catalyst coated membrane as one or more pieces;
(ii) bringing in contact the one or more catalyst coated membrane pieces provided according to (i) with a first mixture comprising water and a leaching agent, and subjecting to leaching conditions, obtaining a mixture M1 comprising the metal dissolved in the first mixture and one or more catalyst coated membrane pieces depleted in the metal;
(iii) separating the one or more catalyst coated membrane pieces depleted in the metal obtained according to (ii) from the metal dissolved in the first mixture obtained according to (ii);
(iv) bringing in contact the one or more catalyst coated membrane pieces depleted in the metal obtained according to (iii) with a second mixture comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second mixture and one or more membrane pieces depleted in the at least portion of the catalytic coating;
(v) separating the one or more membrane pieces depleted in the at least portion of the catalytic coating obtained according to (iv) from the at least portion of the catalytic coating present in the second mixture obtained according to (iv), with A2_{M}≤A1_{M}, A2_{M} being the amount of the metal in the one or more membrane pieces depleted in catalytic coating obtained according to (iv) and A1_{M} being the amount of the metal in the one or more catalyst coated membrane pieces depleted in the metal obtained according to (ii).

Hence, the present invention describes a new advantageous process where the metals, e.g. platinum group metals, gold, silver, copper, nickel, cobalt, rare earth metals, gallium, indium, germanium, and alloys or compounds of these, are first leached from the CCM and afterwards the remaining CCM depleted of said metals is subjected to a delamination treatment to obtain the membrane polymer and the residual coating comprising the binder polymer of the coating and additives like for example carbon black as conductivity enhancing material.

Preferably, the polymer comprised in the catalytic coating is a ionomer, more preferably a fluorocarbon-containing ionomer, more preferably a perfluorosulfonic acid (PFSA) ionomer.

Preferably, the catalytic coating further comprises one or more additives, the one or more additives being more preferably carbon black.

Preferably, the catalytic coating further comprises a substrate for supporting the metal, wherein more preferably the porous substrate is a high surface area support.

In the context of the present invention, the metal comprised in the catalytic coating is selected from the group consisting of platinum, iridium, rhodium, palladium, osmium, ruthenium, gold, silver, copper, nickel, cobalt, lanthanum, scandium, yttrium, cerium, praseodymium, neodymium, promethium, samarium, europium, gadolinium, terbium, dysprosium, holmium, erbium, thulium, ytterbium, lutetium, gallium, indium, germanium, alloys of two or more thereof and mixtures of two or more thereof.

In the context of the present invention, the term “metal” refers to the metal present as an element or as a compound, such as an oxide.

Preferably the metal comprised in the catalytic coating is selected from the group consisting of platinum, iridium, rhodium, osmium, palladium, ruthenium, gold, silver, copper, nickel, cobalt, lanthanum, scandium, yttrium, cerium, praseodymium, neodymium, promethium, samarium, europium, gadolinium, terbium, dysprosium, holmium, erbium, thulium, ytterbium, lutetium, alloys of two or more thereof and mixtures of two or more thereof, more preferably the metal comprised in the catalytic coating is selected from group consisting of platinum, iridium, rhodium, palladium, ruthenium, gold, silver, copper, nickel, cobalt, alloys of two or more thereof and mixtures of two or more thereof, more preferably from the group consisting of platinum, iridium, rhodium, palladium, ruthenium, gold, silver, copper, nickel, cobalt, alloys of two or more thereof and mixtures of two or more thereof.

Preferably the metal comprised in the catalytic coating is selected from the group consisting of platinum group metals, alloys thereof and mixtures thereof, more preferably is a platinum group metal, more preferably is platinum, iridium, alloys thereof and mixtures thereof, more preferably is platinum or iridium.

Thus, preferably the present invention relates to a recycling process for recovering a platinum group metal from a catalyst coated membrane comprising a fluorocarbon-containing ionomer membrane and a catalytic coating comprising a polymer and the platinum group metal, the process comprising
(i) providing the catalyst coated membrane as one or more pieces;
(ii) bringing in contact the one or more catalyst coated membrane pieces provided according to (i) with a first mixture comprising water and a leaching agent, and subjecting to leaching conditions, obtaining a mixture M1 comprising the platinum group metal dissolved in the first mixture and one or more catalyst coated membrane pieces depleted in the platinum group metal;
(iii) separating the one or more catalyst coated membrane pieces depleted in the platinum group metal obtained according to (ii) from the platinum group metal dissolved in the first mixture obtained according to (ii);
(iv) bringing in contact the one or more catalyst coated membrane pieces depleted in the platinum group metal obtained according to (iii) with a second mixture comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second solution and one or more membrane pieces depleted in the at least portion of the catalytic coating;
(v) separating the one or more membrane pieces depleted in the at least portion of the catalytic coating obtained according to (iv) from the at least portion of the catalytic coating present in the second mixture obtained according to (iv), with A2_{M}≤A1_{M}, A2_{M} being the amount of the platinum group metal in the one or more membrane pieces depleted in catalytic coating obtained according to (iv) and A1_{M} being the amount of the platinum group metal in the one or more catalyst coated membrane pieces depleted in the platinum group metal obtained according to (ii).

Thus, preferably the present invention relates to a recycling process for recovering platinum from a catalyst coated membrane comprising a fluorocarbon-containing ionomer membrane and a catalytic coating comprising a polymer and platinum, the process comprising
(i) providing the catalyst coated membrane as one or more pieces;
(ii) bringing in contact the one or more catalyst coated membrane pieces provided according to (i) with a first mixture comprising water and a leaching agent, and subjecting to leaching conditions, obtaining a mixture M1 comprising platinum dissolved in the first mixture and one or more catalyst coated membrane pieces depleted in platinum;
(iii) separating the one or more catalyst coated membrane pieces depleted in platinum obtained according to (ii) from the platinum dissolved in the first mixture obtained according to (ii);
(iv) bringing in contact the one or more catalyst coated membrane pieces depleted in platinum obtained according to (iii) with a second mixture comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second solution and one or more membrane pieces depleted in the at least portion of the catalytic coating;
(v) separating the one or more membrane pieces depleted in the at least portion of the catalytic coating obtained according to (iv) from the at least portion of the catalytic coating present in the second mixture obtained according to (iv), with A2_{M}≤A1_{M}, A2_{M} being the amount of platinum in the one or more membrane pieces depleted in catalytic coating obtained according to (iv) and A1_{M} being the amount of platinum in the one or more catalyst coated membrane pieces depleted in platinum obtained according to (ii).

Preferably, the present invention relates to a recycling process for recovering iridium from a catalyst coated membrane comprising a fluorocarbon-containing ionomer membrane and a catalytic coating comprising a polymer and iridium, the process comprising
(i) providing the catalyst coated membrane as one or more pieces;
(ii) bringing in contact the one or more catalyst coated membrane pieces provided according to (i) with a first mixture comprising water and a leaching agent, and subjecting to leaching conditions, obtaining a mixture M1 comprising iridium dissolved in the first mixture and one or more catalyst coated membrane pieces depleted in iridium;
(iii) separating the one or more catalyst coated membrane pieces depleted in iridium obtained according to (ii) from the iridium dissolved in the first mixture obtained according to (ii);
(iv) bringing in contact the one or more catalyst coated membrane pieces depleted in iridium obtained according to (iii) with a second mixture comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second solution and one or more membrane pieces depleted in the at least portion of the catalytic coating;
(v) separating the one or more membrane pieces depleted in the at least portion of the catalytic coating obtained according to (iv) from the at least portion of the catalytic coating present in the second mixture obtained according to (iv), with A2_{M}≤A1_{M}, A2_{M} being the amount of iridium in the one or more membrane pieces depleted in catalytic coating obtained according to (iv) and A1_{M} being the amount of iridium in the one or more catalyst coated membrane pieces depleted in iridium obtained according to (ii).

In the context of the present invention, it is preferred that the fluorocarbon-containing ionomer membrane is coated on both of its sides, wherein at least one side is coated with the catalytic coating. Indeed, it is conceivable that the other side be coated with a catalytic coating comprising a polymer and a platinum group metal different to the platinum group metal comprised in the other catalytic coating. According to the aforementioned possibility, more than one platinum group metal can be recovered thanks to the process of the present invention in steps (ii) and (iii). For example, platinum and iridium can be recovered in said steps if present in the catalytic coatings.

In the context of the present invention, preferably the fluorocarbon-containing ionomer membrane is a perfluorosulfonic acid (PFSA) ionomer membrane.

Preferably (i) comprises
(i.1) providing a catalyst coated membrane assembly comprising a catalyst coated membrane and sub-gaskets;
(i.2) cutting the catalyst coated membrane assembly into pieces;
(i.3) sorting the pieces obtained according to (i.2) in at least two different streams, obtaining a first stream comprising one or more pieces of the catalyst coated membrane, said one or more pieces being depleted in sub-gasket, and a second stream comprising the sub-gaskets.

Step (i.1) may comprise
providing a membrane electrode assembly comprising a catalyst coated membrane assembly, one or more gaskets and one or more gas diffusion layer, the one or more gaskets being located on the one or more gas diffusion layers and the one or more gas diffusion layers being located on the catalyst coated membrane assembly;
removing the one or more gaskets, subsequently removing the one or more gas diffusion layer, obtaining the catalyst coated membrane assembly, said assembly comprising a catalyst coated membrane and sub-gaskets.

Preferably, cutting according to (i.2) is performed with a cutting device, the cutting device being more preferably rotative knifes, a punching tool (e.g. rotational punch), guillotine, four shaft shredder, single shaft shredder, two shaft shredder, or rotor shears, more preferably rotative knifes or a punching tool (e.g. rotational punch).

Preferably, the average surface of the pieces obtained according to (i.2) is in the range of from 0.1 to 300 cm², more preferably in the range of from 0.5 to 25 cm², more preferably in the range of from 0.9 to 5 cm².

Preferably, the one or more pieces of the catalyst coated membrane obtained according to (i.3) are free of sub-gaskets.

Preferably, sorting according to (i.3) is operated manually or automated.

Preferably sorting according to (i.3) is an optical sorting, more preferably the optical sorting is hyperspectral or UV or VIS sorting or infrared sorting, more preferably near-infrared sorting or mid-infrared sorting. It is conceivable that the material may also be irradiated by microwave radiation and sorting may occur according to the heat taken-up by particles of different composition.

Preferably, the leaching agent comprised in the first mixture used according to (ii) is selected from the group consisting of a Brønsted acid, a Brønsted base or a complexing agent.

As to the acid, preferably it is hydrochloric acid, sulfuric acid, nitric acid or an organic acid, such as methane sulfonic acid, formic acid and citric acid.

As to the base, preferably it is an alkali metal hydroxide, such as potassium hydroxide and sodium hydroxide, an alkaline earth metal hydroxide, an alkali metal carbonate, an alkaline earth metal carbonate or an alkaline earth metal oxide.

As to the complexing agent, preferably it is ammonia; a compound comprising one or more of an amino group and a thio group; a crown ether; an amino derivative crown ether; a thio derivative crown ether; a cyclophane; an amino derivative cyclophane and a thio derivative cyclophane.

Preferably the leaching agent comprised in the first mixture used according to (ii) is a Brønsted acid or a Brønsted base, more preferably a Brønsted acid.

Preferably the leaching agent comprised in the first mixture used according to (ii) is hydrochloric acid.

Preferably, the first mixture consists of the leaching agent and water, in particular when the leaching agent is nitric acid.

Preferably, the first mixture used according to (ii) further comprises an oxidizing agent, wherein the oxidizing agent is more preferably one or more of chlorate, perchlorates, hypochlorite, chlorine, bromine, ozone, oxygen, hydrogen peroxide, peroxosulfates, chromates, permanganates, ferrates and Fenton's reagent (hydrogen peroxide and ferrous iron), more preferably is one or more of chlorate, chlorine, ozone, oxygen and hydrogen peroxide, more preferably is chlorine (Cl₂) or chlorate, such as alkali metal chlorate, more preferably sodium chlorate.

Preferably, the first mixture comprises, more preferably consist of, the leaching agent, the oxidizing agent and water.

Preferably, the oxidizing agent is used in stoichiometric excess to the metal to be recovered.

Preferably, when the oxidizing agent is sodium chlorate and the metal platinum, the molar ratio of NaClO₃:Pt is in the range of from 2:1 to 10:1, more preferably in the range of from 4:1 to 8:1. In the context of the present invention, the metal content can be easily determined by ICP or XRF, according to the knowledge of a person skilled in the art.

Preferably, the solid content in the first mixture is in the range of from 1 to 30 weight-%, more preferably from 1 to 20 weight-%, based on the weight of the first mixture.

Preferably, the first mixture used according to (ii) comprises at least 10 weight-%, more preferably from 10 to 80 weight-%, more preferably from 20 to 50 weight-%, more preferably from 26 to 36 weight-%, of the leaching agent, based on the weight of the first mixture.

Preferably, the first mixture is an aqueous solution.

Preferably bringing in contact the one or more catalyst coated membrane pieces provided according to (i) with the first mixture comprising water and a leaching agent, and subjecting to leaching conditions according to (ii) comprises
introducing the one or more catalyst coated membrane pieces provided according to (i) into a reactor unit comprising the first mixture, mixing, and heating the obtained mixture to a temperature in the range of from 15 to 200° C., more preferably in the range of from 20 to 150° C., more preferably in the range of from 60 to 100° C.

Preferably, heating is performed up to the temperatures at which the vapor pressure of the first aqueous mixture equals the atmospheric pressure. At higher temperatures the reaction is performed under pressure. Pressurization may be also advantageous in case of gaseous reagents e. g. ammonia or chlorine or ozone. Pressurization will increase the partial pressure in the gas phase and by this improve the solubility and reactivity of these gaseous reagents.

Preferably the reactor unit is free of a grinder or granulator.

When applying pressure, the reactor unit used according to (ii) is preferably a pressure reactor unit, more preferably at a pressure in the reactor unit in the range of from 0.5 to 100 barg, more preferably from 5 to 200 barg.

Alternatively, when the reaction is not performed under pressure, the reactor unit is a stirred vessel reactor. In particular, without wanted to be bound to any theory, stirring will generally improve the mixing of the solid and liquid and gaseous components of the mixture.

Preferably, in the context of the present invention, heating according to (ii) is performed under reflux.

Preferably, heating according to (ii) is performed for a duration in the range of from 0.1 to 50 h, more preferably in the range of from 0.1 h to 24 h, more preferably in the range of from 0.5 h to 4 h. In the context of the present invention, it is noted that the duration can vary depending on the size and type of vessel as know by the skilled person. The duration mentioned herewith is the duration of the heating at a given temperature (not the duration of the heating-up in order to arrive at the given temperature or cooling down).

In the case of a continuous operated reaction these times refer to the average residence time in a continuously operated reactor unit (one reactor). If the reactor unit comprises at least two reactors in series, these times corresponds to the average residence time within each reactor of the reactor cascade.

Preferably separating according to (iii) comprises passing M1 obtained according to (ii) through a solid-liquid separation unit, the solid-liquid separation unit more preferably being a sieve or a filter, more preferably a sieve.

Preferably separating according to (iii) further comprises rinsing the one or more catalyst coated membrane pieces on the solid-liquid separation unit with the leaching agent and/or water, more preferably deionized water.

In the context of the present invention, it is noted that the rinsing step can be advantageous in order to remove any potential portion of the first mixture which could remain on the membrane pieces. This rinsing will also ensure that all valuable metal dissolved in the first liquid will be recovered.

Preferably, the metal dissolved in the first mixture obtained according to (iii) is subjected to one or more subsequent treatments, such as hydrometallurgical processes to recover the metals either as pure metals or metal salts or mixtures of metals or metal salts

Preferably, A1_{M}<A0_{M}, A1_{M} being the amount of the metal in the one or more catalyst coated membrane pieces depleted in the metal obtained according to (ii) and A0_{M} being the amount of the metal in the catalyst coated membrane provided according to (i).

Preferably, the one or more catalyst coated membrane pieces, depleted in the metal, obtained according to (ii) has a reduced amount of the metal of from 50 to 100 weight-%, more preferably from 80 to 100 weight-%, more preferably from 90 to 100 weight-%, more preferably in the range of from 95 to 100 weight-%, more preferably in the range of from 98 to 100 weight-%, compared to the catalyst coated membrane provided according to (i).

Preferably the second mixture used in (iv) comprises a C₁ to C₈ alkyl alcohol, more preferably a C₃ to C₆ alkyl alcohol.

Preferably the second mixture used in (iv) is an aqueous mixture, more preferably the second mixture used in (iv) consists of a C₁ to C₈ alkyl alcohol, more preferably a C₃ to C₆ alkyl alcohol, and water.

In the context of the present invention, the second mixture is capable to at least partially dissolve or swell the coating by this weakening or solve the adhesion between the coating and the membrane.

Preferably, the C₁ to C₈ alkyl alcohol is one or more of methanol, ethanol, isopropanol, n-propanol, butan-2-ol, isobutanol, and n-butanol, more preferably isopropanol.

Preferably, the weight ratio of the one or more of a C₁ to C₈ alkyl alcohol, a C₁ to C₈ alkyl ketone and a C₁ to C₈ alkyl ester relative to water in the second mixture used in (iv) is in the range of from 0.1:1 to 1:0, more preferably in the range of from 0.1:1 to 1:0.1, more preferably in the range of from 0.2:1 to 1:0.2.

In the cases of compounds containing more than 3 C-atoms the upper limit of the water content is given by the miscibility of the water in this compound.

Preferably bringing in contact the one or more catalyst coating membrane pieces depleted in the metal obtained according to (iii) with a second mixture comprising one or more of a C₁ to C₈ alkyl alcohol, a C₁ to C₈ alkyl ketone and a C₁ to C₈ alkyl ester, and subjecting to delamination conditions according to (iv) comprises
introducing the one or more catalyst coating membrane pieces depleted in the metal obtained according to (iii) into a container comprising the second mixture, mixing, more preferably shaking, and optionally applying shear forces to the one or more membrane pieces, more preferably by stirring, using fluid jets, scrapping, or brushing.

Preferably separating according to (v) comprises removing the one or more catalyst coated membrane pieces from the second mixture.

Preferably, separating according to (v) comprises passing M2 obtained according to (iv) through a solid-liquid separation unit, the solid-liquid separation unit more preferably being a sieve or a filter or a centrifuge or a decanter centrifuge, more preferably a sieve.

Optionally, the process further comprises after (v)
rinsing the obtained one or more catalyst coated membrane pieces with water, preferably deionized water,
passing the rinsed one or more catalyst coated membrane pieces suspended in water in a stirring unit, more preferably a blade granulator or a rotor stator for a subsequent delamination step, obtaining at least a portion of the remaining catalytic coating and one or more membrane pieces depleted in the at least portion of the catalytic coating.

Preferably separating according to (v) further comprises
rinsing the one or more catalyst coated membrane pieces with a third mixture comprising one or more of a C₁ to C₈ alkyl alcohol, a C₁ to C₈ alkyl ketone and a C₁ to C₈ alkyl ester.

Preferably, the third mixture used according to (v) for rinsing is the same as the second mixture used in (iv). The third mixture is preferably an aqueous mixture, more preferably is an aqueous solution of a C₁ to C₈ alkyl alcohol and water, more preferably an aqueous solution of isopropanol and water.

Preferably, the process further comprising rinsing the one or more catalyst coated membrane pieces with a third mixture comprising a C₁ to C₈ alkyl alcohol and subsequently rinsing said one or more catalyst coated membrane pieces with water, more preferably deionized water.

Preferably, the process of the present invention further comprises
(vi) drying the one or more membrane pieces depleted in the at least portion of the catalyst coating obtained according to (v).

Preferably, drying according to (vi) is performed at temperatures between 25 and 250° C. depending on the used reagent as well known by the skilled person in the art. It is possible that the drying be performed under reduced pressure.

Preferably, the platinum group metal content in the one or more membrane pieces obtained according to (v), more preferably (iv), is reduced from 80 to 100%, more preferably from 90 to 100%, more preferably from 95 to 100%, more preferably from 98 to 100%, compared to the platinum group metal content in the catalyst coated membrane.

Preferably, the process further comprises introducing the dried one or more membrane pieces obtained according to (vi) into a container with an aqueous mixture having a pH in the range of from 0 to 6.5, more preferably from 1 to 3 obtained a mixture; and heating said mixture to a temperature in the range of from 20 to 100° C. It is believed that this steps permits to recover the proton conductivity of the membrane.

Preferably, the process further comprises
(vii) recovering the polymer comprised in the at least portion of the catalyst coating obtained according to (v).

Preferably, recovering the polymer according to (vii) comprises
passing the at least portion of the catalyst coating present in the second mixture obtained according to (v) in a separation unit, obtaining the polymer, more preferably the polymer being a ionomer, more preferably a fluoro-containing ionomer.

Preferably, said separation unit is a filter, a centrifuge or a decanter.

The present invention further relates to a unit for carrying out the process according to the present invention, the unit comprising
a reactor unit for subjecting to leaching conditions the one or more catalyst coated membrane pieces with the first mixture;
a means for introducing the catalyst coated membrane as one or more pieces;
a means for introducing the first mixture;
a means for removing M1 from the reactor unit;
a separation unit;
a means for introducing M1 into the separation unit;
a container for subjecting to delamination conditions the one or more catalyst coated membrane pieces depleted in the metal;
a means for introducing the one or more catalyst coated membrane pieces depleted in the metal into the container;
a means for introducing the second mixture into the container;
a means for removing M2 from the container;
a means for separating the at least a portion of the catalytic coating present in the second mixture from the one or more membrane pieces depleted in the at least portion of the catalytic coating.

In the context of the present invention, it is noted that the reactor unit for subjecting to leaching conditions the one or more catalyst coated membrane pieces with the first mixture is distinct from the container for subjecting to delamination conditions the one or more catalyst coated membrane pieces depleted in the metal. Similarly, the means used for the reactor units differ from the means used for the container.

Preferably the reactor unit is free of a grinder or granulator.

The present invention further relates to a process for preparing a catalyst coated membrane, preferably for fuel cell, the process comprising
using a metal, more preferably platinum group metal, more preferably platinum or iridium, obtained according to a recycling process according to the present invention.

In the context of the present invention, as the process avoid high temperature treatments the remaining polymers can be recovered and may be utilized in different applications comprising, namely the production of new fuel cells or electrolyzer cells membranes for the chlorine alkaline electrolysis or the production of breathing water-proof coatings and the like.

The present invention further relates to a process for preparing a catalyst coated membrane, preferably for fuel cell, the process comprising
using a polymer, more preferably a ionomer, obtained according a recycling process according to the present invention. The polymer obtained according a recycling process according to the present invention may be employed as a mixture with pristine polymer material.

The present invention further relates to a process for preparing a catalyst coated membrane, preferably for fuel cell, the process comprising
using one or more membrane pieces obtained according a recycling process according to the present invention.

The present invention further relates to a process for preparing a catalyst coated membrane, preferably for fuel cell, the process comprising
using one or more of
a metal, preferably a platinum group metal, more preferably platinum or iridium, obtained according to a recycling process according to the present invention;
a polymer, preferably a ionomer, obtained according a recycling process according to the present invention; and
one or more membrane pieces obtained according a recycling process according to the present invention.

The present invention further relates to a process for preparing a catalyst coated membrane for fuel cell, the process comprising
(a) performing the process according to the present invention, obtaining a metal, preferably a platinum group metal, more preferably platinum or iridium, a polymer, preferably a ionomer, and one or more membrane pieces;
(b) using one or more of the metal, the polymer and the one or membrane pieces obtained according to (a) for obtaining a catalyst coated membrane for fuel cell.

The present invention further relates to a use of one or more of a metal, preferably a platinum group metal, more preferably platinum or iridium, obtained according to the present invention, a polymer, preferably a ionomer, obtained according to the present invention, and one or more membrane pieces obtained according to the present invention, for preparing a catalyst coated membrane for fuel cell.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 3”, every embodiment in this range is meant to be explicitly disclosed for the skilled person, i.e. the wording of this term is to be understood by the skilled person as being synonymous to “The process of any one of embodiments 1, 2 and 3”. Further, it is explicitly noted that the following set of embodiments represents a suitably structured part of the general description directed to preferred aspects of the present invention, and, thus, suitably supports, but does not represent the claims of the present invention.
1. A recycling process for recovering a metal from a catalyst coated membrane comprising a fluorocarbon-containing ionomer membrane and a catalytic coating comprising a polymer and the metal, said metal being selected from the group consisting of platinum group metals, gold, silver, copper, nickel, cobalt, rare earth metals, gallium, indium, germanium, alloys of two or more thereof and mixtures of two or more thereof, the process comprising
   (i) providing the catalyst coated membrane as one or more pieces;
   (ii) bringing in contact the one or more catalyst coated membrane pieces provided according to (i) with a first mixture comprising water and a leaching agent, and subjecting to leaching conditions, obtaining a mixture M1 comprising the metal dissolved in the first mixture and one or more catalyst coated membrane pieces depleted in the metal;
   (iii) separating the one or more catalyst coated membrane pieces depleted in the metal obtained according to (ii) from the metal dissolved in the first mixture obtained according to (ii);
   (iv) bringing in contact the one or more catalyst coated membrane pieces depleted in the metal obtained according to (iii) with a second mixture comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second mixture and one or more membrane pieces depleted in the at least portion of the catalytic coating;
   (v) separating the one or more membrane pieces depleted in the at least portion of the catalytic coating obtained according to (iv) from the at least portion of the catalytic coating present in the second mixture obtained according to (iv), with A2_{M}≤A1_{M}, A2_{M} being the amount of the metal in the one or more membrane pieces depleted in catalytic coating obtained according to (iv) and A1_{M} being the amount of the metal in the one or more catalyst coated membrane pieces depleted in the metal obtained according to (ii).
2. The process of embodiment 1, wherein the polymer comprised in the catalytic coating is a ionomer, more preferably a fluorocarbon-containing ionomer, more preferably a perfluorosulfonic acid (PFSA) ionomer.
3. The process of embodiment 1 or 2, wherein the metal comprised in the catalytic coating is selected from the group consisting of platinum, iridium, rhodium, osmium, palladium, ruthenium, gold, silver, copper, nickel, cobalt, lanthanum, scandium, yttrium, cerium, praseodymium, neodymium, promethium, samarium, europium, gadolinium, terbium, dysprosium, holmium, erbium, thulium, ytterbium, lutetium, alloys of two or more thereof and mixtures of two or more thereof, preferably the metal comprised in the catalytic coating is selected from group consisting of platinum, iridium, rhodium, palladium, ruthenium, gold, silver, copper, nickel, cobalt, alloys of two or more thereof and mixtures of two or more thereof, more preferably from the group consisting of platinum, iridium, rhodium, palladium, ruthenium, gold, silver, copper, nickel, cobalt, alloys of two or more thereof and mixtures of two or more thereof.
4. The process of embodiment 3, wherein the metal comprised in the catalytic coating is selected from the group consisting of platinum group metals, alloys thereof and mixtures thereof, more preferably is a platinum group metal, more preferably is platinum, iridium, alloys thereof and mixtures thereof, more preferably is platinum or iridium.
5. The process of any one of embodiments 1 to 4, wherein the fluorocarbon-containing ionomer membrane is coated on both of its sides, wherein at least one side is coated with the catalytic coating.
6. The process of any one of embodiments 1 to 5, wherein the fluorocarbon-containing ionomer membrane is a perfluorosulfonic acid (PFSA) ionomer membrane.
7. The process of any one of embodiments 1 to 6, wherein (i) comprises
   (i.1) providing a catalyst coated membrane assembly comprising a catalyst coated membrane and sub-gaskets;
   (i.2) cutting the catalyst coated membrane assembly into pieces;
   (i.3) sorting the pieces obtained according to (i.2) in at least two different streams, obtaining a first stream comprising one or more pieces of the catalyst coated membrane, said one or more pieces being depleted in sub-gasket, and a second stream comprising the sub-gaskets.
8. The process of any one of embodiments 1 to 7, wherein the leaching agent comprised in the first mixture used according to (ii) is selected from the group consisting of a Brønsted acid, a Brønsted base or a complexing agent;
   wherein the acid preferably is hydrochloric acid, sulfuric acid, nitric acid or an organic acid;
   wherein the base preferably is an alkali metal hydroxide, an alkaline earth metal hydroxide, an alkali metal carbonate, an alkaline earth metal carbonate or an alkaline earth metal oxide;
   wherein the complexing agent preferably is ammonia, a compound comprising one or more of an amino group and a thio group, a crown ether, an amino derivative crown ether, a thio derivative crown ether, a cyclophane, an amino derivative cyclophane and a thio derivative cyclophane;
   preferably wherein the leaching agent comprised in the first mixture used according to (ii) is a Brønsted acid or a Brønsted base, more preferably a Brønsted acid.
9. The process of any one of embodiments 1 to 8, wherein the first mixture used according to (ii) further comprises an oxidizing agent, wherein the oxidizing agent is preferably one or more of chlorate, perchlorates, hypochlorite, chlorine, bromine, ozone, oxygen, hydrogen peroxide, peroxosulfates, chromates, permanganates, ferrates and Fenton's reagent (hydrogen peroxide and ferrous iron), preferably is one or more of chlorate, chlorine, ozone, oxygen and hydrogen peroxide, more preferably is chlorine (Cl₂) or chlorate.
10. The process of any one of embodiments 1 to 9, wherein the first mixture used according to (ii) comprises at least 10 weight-%, preferably from 10 to 80 weight-%, more preferably from 20 to 50 weight-%, more preferably from 26 to 36 weight-%, of the leaching agent, based on the weight of the first mixture.
11. The process of any one of embodiments 1 to 10, wherein bringing in contact the one or more catalyst coated membrane pieces provided according to (i) with the first mixture comprising water and a leaching agent, and subjecting to leaching conditions according to (ii) comprises
   introducing the one or more catalyst coated membrane pieces provided according to (i) into a reactor unit comprising the first mixture, mixing, and heating the obtained mixture to a temperature in the range of from 15 to 200° C., preferably in the range of from 20 to 150° C., more preferably in the range of from 60 to 100° C.
12. The process of embodiment 11, wherein heating according to (ii) is performed under reflux.
13. The process of embodiment 11 or 12, wherein heating according to (ii) is performed for a duration in the range of from 0.1 to 50 h, preferably from 0.1 h to 24 h, more preferably in the range of from 0.5 h to 4 h.
14. The process of any one of embodiments 1 to 13, wherein separating according to (iii) comprises passing M1 obtained according to (ii) through a solid-liquid separation unit, the solid-liquid separation unit preferably being a sieve or a filter, more preferably a sieve.
15. The process of embodiment 14, wherein separating according to (iii) further comprises rinsing the one or more catalyst coated membrane pieces on the solid-liquid separation unit with water, preferably deionized water.
16. The process of any one of embodiments 1 to 15, wherein the second mixture used in (iv) comprises a C₁ to C₈ alkyl alcohol, preferably a C₃ to C₆ alkyl alcohol.
17. The process of any one of embodiments 1 to 16, wherein the C₁ to C₈ alkyl alcohol is one or more of methanol, ethanol, isopropanol, n-propanol, butan-2-ol, isobutanol, and n-butanol, preferably isopropanol.
18. The process of any one of embodiments 1 to 17, wherein the weight ratio of the one or more of a C₁ to C₈ alkyl alcohol, a C₁ to C₈ alkyl ketone and a C₁ to C₈ alkyl ester relative to water in the second mixture used in (iv) is in the range of from 0.1:1 to 1:0, preferably in the range of from 0.1:1 to 1:0.1, more preferably in the range of from 0.2:1 to 1:0.2.
19. The process of any one of embodiments 1 to 18, wherein bringing in contact the one or more catalyst coating membrane pieces depleted in the metal obtained according to (iii) with a second mixture comprising one or more of a C₁ to C₈ alkyl alcohol, a C₁ to C₈ alkyl ketone and a C₁ to C₈ alkyl ester, and subjecting to delamination conditions according to (iv) comprises
   introducing the one or more catalyst coating membrane pieces depleted in the metal obtained according to (iii) into a container comprising the second mixture, mixing, preferably shaking, and optionally applying shear forces to the one or more membrane pieces, preferably by stirring, using fluid jets, scrapping, or brushing.
20. The process of any one of embodiments 1 to 19, wherein separating according to (v) comprises removing the one or more catalyst coated membrane pieces from the second mixture.
21. The process of any one of embodiments 1 to 20, wherein separating according to (v) further comprises rinsing the one or more catalyst coated membrane pieces with a third mixture comprising one or more of a C₁ to C₈ alkyl alcohol, a C₁ to C₈ alkyl ketone and a C₁ to C₈ alkyl ester.
22. The process of any one of embodiments 1 to 21, further comprising
   (vi) drying the one or more membrane pieces depleted in the at least portion of the catalyst coating obtained according to (v).
23. The process of embodiment 22, further comprising introducing the dried one or more membrane pieces obtained according to (vi) into a container with an aqueous mixture having a pH in the range of from 0 to 6.5, preferably from 1 to 3, obtaining a mixture; and heating said mixture to a temperature in the range of from 20 to 100° C.
24. The process of any one of embodiments 1 to 23, further comprising
   (vii) recovering the polymer comprised in the at least portion of the catalyst coating obtained according to (v).
25. The process of embodiment 24, wherein recovering the polymer according to (vii) comprises
   passing the at least portion of the catalyst coating present in the second mixture obtained according to (v) in a separation unit, obtaining the polymer, preferably the polymer being a ionomer, more preferably a fluoro-containing ionomer.
26. A unit for carrying out the process according to any one of embodiments 1 to 25, the unit comprising
   a reactor unit for subjecting to leaching conditions the one or more catalyst coated membrane pieces with the first mixture;
   a means for introducing the catalyst coated membrane as one or more pieces;
   a means for introducing the first mixture;
   a means for removing M1 from the reactor unit;
   a separation unit;
   a means for introducing M1 into the separation unit;
   a container for subjecting to delamination conditions the one or more catalyst coated membrane pieces depleted in the metal;
   a means for introducing the one or more catalyst coated membrane pieces depleted in the metal into the container;
   a means for introducing the second mixture into the container;
   a means for removing M2 from the container;
   a means for separating the at least a portion of the catalytic coating present in the second mixture from the one or more membrane pieces depleted in the at least portion of the catalytic coating.
27. A process for preparing a catalyst coated membrane for fuel cell, the process comprising using a metal, preferably the platinum group metal, more preferably platinum or iridium, obtained according to a recycling process according to any one of embodiments 1 to 25.
28. A process for preparing a catalyst coated membrane for fuel cell, the process comprising using a polymer, preferably a ionomer, obtained according a recycling process according to any one of embodiments 1 to 25.
29. A process for preparing a catalyst coated membrane for fuel cell, the process comprising using one or more membrane pieces obtained according a recycling process according to any one of embodiments 1 to 25.
30. A process for preparing a catalyst coated membrane for fuel cell, the process comprising using one or more of
   a metal, preferably a platinum group metal, more preferably platinum or iridium, obtained according to a recycling process according to any one of embodiments 1 to 25;
   a polymer, preferably a ionomer, obtained according a recycling process according to any one of embodiments 1 to 25; and
   one or more membrane pieces obtained according a recycling process according to any one of embodiments 1 to 25.
31. A process for preparing a catalyst coated membrane for fuel cell, the process comprising
   (a) performing the process according to any one of embodiments 1 to 25, obtaining a metal, preferably a platinum group metal, more preferably platinum or iridium, a polymer, preferably a ionomer, and one or more membrane pieces;
   (b) using one or more of the metal, the polymer and the one or membrane pieces obtained according to (a) for obtaining a catalyst coated membrane for fuel cell.
32. Use of one or more of a metal, preferably a platinum group metal, more preferably platinum or iridium, obtained according to any one of embodiments 1 to 25, a polymer, preferably a ionomer, obtained according to any one of embodiments 1 to 25, and one or more membrane pieces obtained according to any one of embodiments 1 to 25, for preparing a catalyst coated membrane for fuel cell.

It is explicitly noted that the above set of embodiments represents a suitably structured part of the general description directed to preferred aspects of the present invention, and, thus, suitably supports, but does not represent the claims of the present invention.

In the context of the present invention, when the term “membrane” is used it refers to a solid membrane as opposed to a dissolved or diluted state. By the action of the second mixture the membrane can take up the liquid or parts of the liquid by this swelling to a considerable extend. However the shape of the membrane will not be changed much except the dimensions. In this respect, the behavior of the coating polymer is much different as it will be partially dissolved and swell in way that the shape of the coating will be lost forming a lump of swollen polymer. This different behavior is a result of either higher polymerization degree and/or cross linking of the membrane polymer compared to the coating polymer.

In the context of the present invention, the term “platinum group metal” is well-known in the art and refers to metals selected from the group consisting of platinum, iridium, palladium, rhodium, osmium and ruthenium.

In the context of the present invention, the term “rare earth metal” is well-known in the art and refers to metals selected from the group consisting of lanthanum, scandium, yttrium, cerium, praseodymium, neodymium, promethium, samarium, europium, gadolinium, terbium, dysprosium, holmium, erbium, thulium, ytterbium and lutetium.

In the context of the present invention, the term “one or pieces” referring to the membrane/coated membranes does not refer to any powder as opposed to what is disclosed in the prior art, such as in WO 2010/132156 A2. Indeed, in WO 2010/132156 A2, the membrane is pulverized which is disadvantageous as it will be not possible afterwards to separate small membrane particles from the coating polymer. The advantage of keeping the membrane in pieces (not as a powder) is that they can more easily be separated from the coating polymer gel. Another disadvantage of the process of WO 2010/132156 A2 is that even if two leaching steps one after the other are performed, this would not permit to recover a portion of the catalytic coating as in step (iv) of the present invention and separate it from the membrane piece. It would at best only permit to further recover the platinum group metal.

In the context of the present invention, the term “delamination conditions” refers to the conditions necessary for delamination of a given coated sample in a solvent, namely for removing at least a portion of the coat. Such conditions can be the mere submersion in the solvent, or can comprise mixing, preferably shaking, and optionally applying shear forces to the sample, preferably by stirring, using fluid jets, scrapping, or brushing.

In the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The present invention is further illustrated by the following examples.

### EXAMPLES

### Composition of the Catalyst Coated Membrane (CCM) Used in the Examples:

In the following examples, a CCM made of a perfluorosulfonic acid (PFSA) polymer membrane* (Nafion™ PFSA membrane commercially available and purchased from Chemours) coated on both sides with a Pt containing carbon-based catalyst with perfluorosulfonic acid (PFSA) polymers as binder was used and carbon black used as an additive. The thickness of the membrane was 10 micrometers and the thickness of the coated membrane was 25 micrometers, namely the total thickness of coating on both sides was 15 micrometer. *The perfluorosulfonic acid (PFSA) polymer (ionomer) membrane was generated by free radicalinitiated copolymerization of a perfluorinated vinyl ether sulfonyl fluoride co-monomer with tetrafluoroethylene (TFE), giving a poly(tetrafluoroethylene) backbone with perfluoroether pendant side chains terminated by sulfonic acid groups.

The composition of the catalyst coated membrane was 45.5 wt.-% F, 0.8 wt.-% S and 10.9 wt.-% Pt, the surface specific weight was 4.2 mg/cm².

### Analytics:

### 1. Determination of F Content

Elemental analysis of fluorine was performed in accordance with DIN EN 14582:2016-12 with regard to the sample preparation for the overall fluorine content determination; the detection method was an ion selective electrode measurement.

### 2. Determination of S Content

Sulfur was determined by catalytical combustion of the sample in an inert gas/oxygen atmosphere the sulfur is hereby converted to a mixture of SO₂ and SO₃. The formed SO₃ was subsequently reduced to SO₂ with copper granules. After drying and separation of the combustion gases, sulfur was detected and quantified as SO₂ via thermal conductivity or IR spectrometer.

### 3. Determination of Platinum Group Metal Content

The platinum group metal, in particular Pt, within the obtained sample solutions were determined by optical emission spectroscopy using an inductively coupled plasma (ICP-OES). Pt was then determined by ICP-OES Agilent 5100 SVDV.

### 4. Pt-Leaching Efficiency Calculation

The Pt-leaching efficiency was calculated by the formula

$$R ( \% ) = ( 1 - \frac{{x}_{Pt}}{{x}_{Pt ( 0 )}} [ \frac{( 1 - {x}_{Pt ( 0 )} )}{( 1 - {x}_{Pt} )} ] ) 100$$

with
R=leaching efficiency;
X_{Pt}=Pt content in membrane after leach;
X_{Pt(0)}=Pt content in membrane before leach.

### Example 1: Recycling Process According to the Present Invention-Platinum Group Metal Leaching Followed by Delamination

### 1. Cutting, Sorting

A catalyst coated membrane attached to its sub-gaskets was provided. In general, the catalyst coated membranes are attached to the sub-gaskets at the welded rim as may be seen in FIG. 1. This assembly was subjected to a cutting step to obtain pieces of approximately 20×20 mm. Such step was carried out manually with a cutting device, namely using scissors. The obtained pieces were sorted manually, in order to separate pieces of the sub-gaskets from pieces of the catalyst coated membrane and pieces of the welded rim.

### 2. Platinum Group Metal Leaching

100 g of an aqueous acidic solution comprising hydrochloric acid (HCl: 33 weight-% based on the weight of the solution+water: 67 weight-% based on the weight of the solution) were introduced in a 250 ml round bottom flask equipped with stirrer and reflux condenser. To this solution, 0.25 g of sodium chlorate were added as an oxidant. Then, 2.0844 g of the CCM cut into approx. 20×20 mm pieces obtained according to 1. was added to the flask. The suspension was placed in an oil bath and heated to 80° C. under stirring for 35 min. The suspension was kept at 80° C. for 9.5 hours in total, after 3.5 hours and after 4.5 hours additional portions of 0.25 g of sodium chlorate were added giving a total amount of sodium chlorate added of 0.75 g (corresponds to a molar ratio NaClO₃:Pt of approx. 6:1). The Pt-leaching efficiency after 4.5 h obtained from the Pt-content of a leached membrane piece measured by XRF employing the formula given in Analytics 4. above was 98.8%. After the leaching, the membrane pieces were separated by a sieve. The membrane pieces were further rinsed with deionized water. A sample of the membrane pieces was taken and analyzed for residual Pt by ICP-OES (see Analytics 3 herein above). The residual Pt-content on the membrane pieces was 0.09 weight-% based on the weight of the tested sample.

The Pt-leaching efficiency was calculated according to the equation disclosed under Analytics 4. herein above and was of 99.3%.

### 3. Delamination

Afterwards the separated and washed membrane pieces (1.2915 g) obtained according to 2. were suspended in a mixture of isopropanol and water (30 weight-% isopropanol+70 weight-% water). This suspension was shaken for 15 min in a shaker at room temperature (about 20° C.). The membrane pieces were removed from the suspension. Adhering coating residues were removed by gentle scraping with a spatula. Finally, each membrane piece was rinsed first with the isopropanol/water mixture and second with pure water. The rinsed membrane pieces were hung-up by clamps and dried at the ambient air. The obtained solvent containing the detached coating was centrifuged (centrifuge Universal 320 R of Andreas Hettich GmbH & Co. KG) at a speed of 5000 rpm for 30 min, obtaining two phases, a clear solvent phase and a gel-like sediment. Both phases were separated by decantation. The gel-like sediment was first dried at ambient air for several days until the isopropanol was evaporated completely and then dried at 80° C. in a circulating air oven for 32 hours.

The clear solvent was evaporated to dryness by a rota-vapor, the residue was dried over night at 80° C. in a circulating air oven.

By this 0.4197 g uncoated membrane free of Pt+0.6313 g coating containing 0.16% Pt and 0.2405 g dissolved polymer were recovered corresponding to a total Pt-recovery of 99.4% which agrees well with the value obtained from the leached membrane sample given above.

The recovered dried membrane pieces contained 66 wt.-% F and 3.0 wt.-% S.

### Comparative Example 1: Recycling Process not According to the Present Invention-Delamination Followed by Platinum Group Metal Leaching

### 1. Cutting, Sorting

Four catalyst coated membranes attached to their sub-gaskets were provided. In general, the catalyst coated membranes are attached to the sub-gaskets at the welded rim as may be seen in FIG. 1. These assemblies were subjected to a manual cutting step in order to remove the sub-gaskets from the catalyst coated membranes. The area of each of the obtained catalyst coated membranes was of about 250 cm². The total mass of these membranes was of 4.4900 g.

### 2. Delamination

The obtained membranes (4.4900 g) were treated with 300 g of a mixture of isopropanol and water (30 weight-% isopropanol+70 weight-% water) in a shaking bath for 20 min at room temperature (about 20° C.). Each membrane was removed from the suspension, and the adhering coating residues were removed by gentle scraping with a spatula from said membranes. Finally, each membrane was rinsed first with the isopropanol/water mixture and second with pure water. The rinsed membranes were hung-up by clamps and dried at the ambient air giving 1.0808 g total dry mass of delaminated membranes.

The obtained solvent containing the detached coating was centrifuged (centrifuge Universal 320 R of Andreas Hettich GmbH & Co. KG) at a speed of 5000 rpm for 30 min, obtaining two phases, a clear solvent phase and a gel-like sediment. Both phases were separated by decantation. The gel-like sediment was transferred into a round bottom flask and the solvent completely evaporated in a rota-vapor at 70° C. in vacuo giving a dry residue of 2.3264 g. The difference between feed mass and the masses of the coating and the membrane of 1.0828 g corresponds to the polymer fraction that was dissolved in the solvent. The recovered dried membranes contained 66.5 wt.-% F and 2.4 wt.-% S.

### 3. Platinum Group Metal Leaching

The 2.3264 g of the dried coating was then treated with 149 g of an aqueous acidic solution comprising hydrochloric acid (HCl: 33 weight-% based on the weight of the solution+water: 67 weight-% based on the weight of the solution) and 1.65 g of sodium chlorate (corresponds to a molar ratio NaClO₃:Pt of approx. 6:1) at 80° C. for 6.5 h. The reaction mixture was filtered, and the solid residue rinsed with 10% hydrochloric acid and afterwards with water until the wash water was neutral. The solid residue was dried over night at 80° C. in a circulating air oven. The dried residue had a mass of 1.8700 g and a residual Pt-content of 0.63%.

The overall Pt-leaching efficiency was calculated according to the equation disclosed under Analytics 4. herein above and was of corresponding to an overall leaching efficiency of 97.6%.

### BRIEF DESCRIPTION OF THE FIGURES

FIG. 1 shows a catalyst coated membranes attached to sub-gaskets at the welded rim to be recycled.

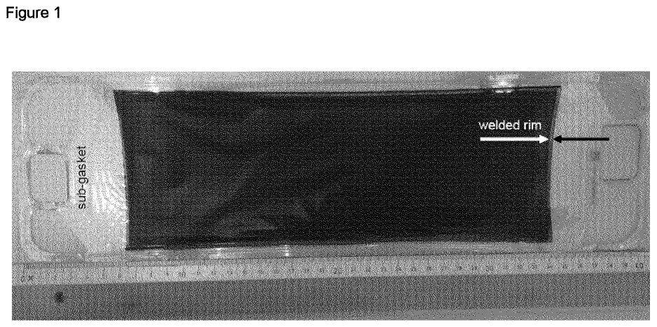

FIG. 2 shows a schematic membrane electrode assembly comprising a catalyst coated membrane (CCM) with sub-gaskets (not illustrated) covered by gas diffusion layers, the gas diffusion layers (4) being covered by flow-field plates (3), metal sheets (2) and metal grids (1). The gas diffusion layers as well as the flow-field plates, metal sheets and metal grids are easily removable.

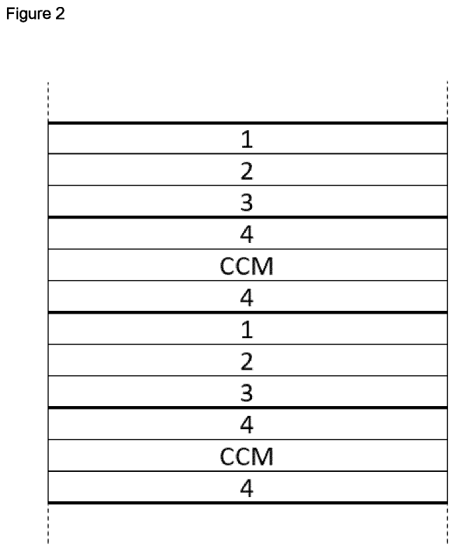

FIG. 3 is a schematic representation of the process according to embodiments of the present invention. The catalyst coated membrane as one or more pieces P(CCM) are introduced into a reactor unit RU together with a first mixture M (L) comprising water and a leaching agent, M (L) and P(CCM) are brought in contact in RU and subjected to leaching conditions, obtaining a mixture M1 comprising the metal dissolved in the first mixture and one or more catalyst coated membrane pieces depleted in the metal. M1 is introduced in a separation unit SU, preferably solid liquid separation unit, obtaining the one or more catalyst coated membrane pieces depleted in the metal as stream F (p) and the metal dissolved in the first mixture as stream F (mt). Further, F (p) is introduced in a container CR together with a second mixture M (D) comprising one or more of a C₁ to C₈ alkyl alcohol, a C₁ to C₈ alkyl ketone and a C₁ to C₈ alkyl ester, and subjecting to delamination conditions, obtaining a mixture M2 comprising at least a portion of the catalytic coating present in the second mixture and one or more membrane pieces depleted in the at least portion of the catalytic coating. M2 is removed from CR. M2 is passed through a solid-liquid separation unit SLU, obtaining F (mb), namely the one or more membrane pieces depleted in the at least portion of the catalytic coating are separated, and F (pol), namely the at least portion of the catalytic coating present in the second mixture, with A2_{M}≤A1_{M}, A2_{M} being the amount of the metal in the one or more membrane pieces depleted in catalytic coating obtained in CR and A1_{M} being the amount of the metal in the one or more catalyst coated membrane pieces depleted in the metal obtained in RU. The process may further comprise using one or more of F (mt), F (pol) and F (mb) for preparing one or more catalyst coated membranes, hence closing the loop.

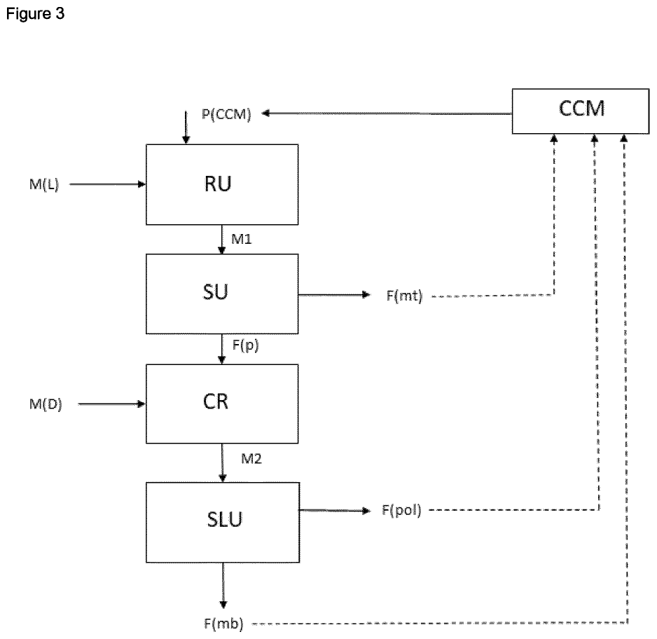

### CITED LITERATURE

WO 2006/073840 A1
WO 2010/132156 A1
WO 2015/010793 A2
WO 2016/156815 A1
EP3000902 B1
EP3957759 A1
EP2036153 B1
WO 2010/132156 A2

1. A recycling process for recovering a metal from a catalyst coated membrane comprising a fluorocarbon-containing ionomer membrane and a catalytic coating comprising a polymer and the metal, said metal being selected from the group consisting of platinum group metals, gold, silver, copper, nickel, cobalt, rare earth metals, gallium, indium, germanium, alloys of two or more thereof and mixtures of two or more thereof, the process comprising
(i) providing the catalyst coated membrane as one or more pieces;
(ii) bringing in contact the one or more catalyst coated membrane pieces provided according to (i) with a first mixture comprising water and a leaching agent, and subjecting to leaching conditions, obtaining a mixture M1 comprising the metal dissolved in the first mixture and one or more catalyst coated membrane pieces depleted in the metal;
(iii) separating the one or more catalyst coated membrane pieces depleted in the metal obtained according to (ii) from the metal dissolved in the first mixture obtained according to (ii);
(iv) bringing in contact the one or more catalyst coated membrane pieces depleted in the metal obtained according to (iii) with a second mixture comprising one or more of a C1 to C8 alkyl alcohol, a C1 to C8 alkyl ketone and a C1 to C8 alkyl ester, and subjecting to delamination conditions, obtaining a mixture M2 comprising at least a portion of the catalytic coating present in the second mixture and one or more membrane pieces depleted in the at least portion of the catalytic coating;
(v) separating the one or more membrane pieces depleted in the at least portion of the catalytic coating obtained according to (iv) from the at least portion of the catalytic coating present in the second mixture obtained according to (iv), with A2M≤A1M, A2M being the amount of the metal in the one or more membrane pieces depleted in catalytic coating obtained according to (iv) and A1M being the amount of the metal in the one or more catalyst coated membrane pieces depleted in the metal obtained according to (ii).

2. The process of claim 1, wherein the polymer comprised in the catalytic coating is a ionomer, preferably a fluorocarbon-containing ionomer, more preferably a perfluorosulfonic acid ionomer.

3. The process of claim 1, wherein the metal comprised in the catalytic coating is selected from the group consisting of platinum group metals, alloys thereof and mixtures thereof, more preferably is a platinum group metal, more preferably is platinum, iridium, alloys thereof and mixtures thereof, more preferably is platinum or iridium.

4. The process of claim 1, wherein (i) comprises
(i.1) providing a catalyst coated membrane assembly comprising a catalyst coated membrane and sub-gaskets;
(i.2) cutting the catalyst coated membrane assembly into pieces;
(i.3) sorting the pieces obtained according to (i.2) in at least two different streams, obtaining a first stream comprising one or more pieces of the catalyst coated membrane, said one or more pieces being depleted in sub-gasket, and a second stream comprising the sub-gaskets.

5. The process of claim 1, wherein the leaching agent comprised in the first mixture used according to (ii) is selected from the group consisting of a Brønsted acid, a Brønsted base or a complexing agent;
wherein the acid preferably is hydrochloric acid, sulfuric acid, nitric acid or an organic acid;
wherein the base preferably is an alkali metal hydroxide, an alkaline earth metal hydroxide, an alkali metal carbonate, an alkaline earth metal carbonate or an alkaline earth metal oxide;
wherein the complexing agent preferably is ammonia, a compound comprising one or more of an amino group and a thio group, a crown ether, an amino derivative crown ether, a thio derivative crown ether, a cyclophane, an amino derivative cyclophane and a thio derivative cyclophane;
preferably wherein the leaching agent comprised in the first mixture used according to (ii) is a Brønsted acid or a Brønsted base, more preferably a Brønsted acid.

6. The process of claim 1, wherein the first mixture used according to (ii) further comprises an oxidizing agent, wherein the oxidizing agent is preferably one or more of chlorate, perchlorates, hypochlorite, chlorine, bromine, ozone, oxygen, hydrogen peroxide, peroxosulfates, chromates, permanganates, ferrates and Fenton's reagent, preferably is one or more of chlorate, chlorine, ozone, oxygen and hydrogen peroxide, more preferably is chlorine or chlorate.

7. The process of claim 1, wherein the first mixture used according to (ii) comprises at least 10 weight-%, preferably from 10 to 80 weight-%, more preferably from 20 to 50 weight-%, more preferably from 26 to 36 weight-%, of the leaching agent, based on the weight of the first mixture.

8. The process of claim 1, wherein bringing in contact the one or more catalyst coated membrane pieces provided according to (i) with the first mixture comprising water and a leaching agent, and subjecting to leaching conditions according to (ii) comprises
introducing the one or more catalyst coated membrane pieces provided according to (i) into a reactor unit comprising the first mixture, mixing, and heating the obtained mixture to a temperature in the range of from 15 to 200° C., preferably in the range of from 20 to 150° C., more preferably in the range of from 60 to 100° C.;
wherein preferably heating according to (ii) is performed under reflux.

9. The process of claim 1, wherein separating according to (iii) comprises passing M1 obtained according to (ii) through a solid-liquid separation unit, the solid-liquid separation unit preferably being a sieve or a filter, more preferably a sieve;
wherein preferably separating according to (iii) further comprises rinsing the one or more catalyst coated membrane pieces on the solid-liquid separation unit with the leaching agent and/or water, more preferably deionized water.

10. The process of claim 1, wherein bringing in contact the one or more catalyst coating membrane pieces depleted in the metal obtained according to (iii) with a second mixture comprising one or more of a C1 to C8 alkyl alcohol, a C1 to C8 alkyl ketone and a C1 to C8 alkyl ester, and subjecting to delamination conditions according to (iv) comprises
introducing the one or more catalyst coating membrane pieces depleted in the metal obtained according to (iii) into a container comprising the second mixture, mixing, preferably shaking, and optionally applying shear forces to the one or more membrane pieces, preferably by stirring, using fluid jets, scrapping, or brushing.

11. The process of claim 1, wherein the weight ratio of the one or more of a C1 to C8 alkyl alcohol, a C1 to C8 alkyl ketone and a C1 to C8 alkyl ester relative to water in the second mixture used in (iv) is in the range of from 0.1:1 to 1:0, preferably in the range of from 0.1:1 to 1:0.1, more preferably in the range of from 0.2:1 to 1:0.2.

12. The process of claim 1, further comprising
(vi) drying the one or more membrane pieces depleted in the at least portion of the catalyst coating obtained according to (v); wherein the process preferably comprises
introducing the dried one or more membrane pieces obtained according to (vi) into a container with an aqueous mixture having a pH in the range of from 0 to 6.5, preferably from 1 to 3, obtaining a mixture; and heating said mixture to a temperature in the range of from 20 to 100° C.

13. The process of claim 1, further comprising
(vii) recovering the polymer comprised in the at least portion of the catalyst coating obtained according to (v); wherein preferably recovering the polymer according to (vii) comprises
passing the at least portion of the catalyst coating present in the second mixture obtained according to (v) in a separation unit, obtaining the polymer, more preferably the polymer being a ionomer, more preferably a fluoro-containing ionomer.

14. A unit for carrying out the process according to claim 1, the unit comprising
a reactor unit for subjecting to leaching conditions the one or more catalyst coated membrane pieces with the first mixture;
a means for introducing the catalyst coated membrane as one or more pieces;
a means for introducing the first mixture;
a means for removing M1 from the reactor unit;
a separation unit;
a means for introducing M1 into the separation unit;
a container for subjecting to delamination conditions the one or more catalyst coated membrane pieces depleted in the metal;
a means for introducing the one or more catalyst coated membrane pieces depleted in the metal into the container;
a means for introducing the second mixture into the container;
a means for removing M2 from the container;
a means for separating the at least a portion of the catalytic coating present in the second mixture from the one or more membrane pieces depleted in the at least portion of the catalytic coating.

15. A process for preparing a catalyst coated membrane for fuel cell, the process comprising
(a) performing the process of claim 1, obtaining
a metal, preferably a platinum group metal, more preferably platinum or iridium, a polymer, preferably a ionomer, and
one or more membrane pieces;
(b) using one or more of the metal, the polymer and the one or membrane pieces obtained according to (a) for obtaining a catalyst coated membrane for fuel cell.

16. The process of claim 2, wherein the metal comprised in the catalytic coating is selected from the group consisting of platinum group metals, alloys thereof and mixtures thereof, more preferably is a platinum group metal, more preferably is platinum, iridium, alloys thereof and mixtures thereof, more preferably is platinum or iridium.

17. The process of claim 2, wherein (i) comprises
(i.1) providing a catalyst coated membrane assembly comprising a catalyst coated membrane and sub-gaskets;
(i.2) cutting the catalyst coated membrane assembly into pieces;
(i.3) sorting the pieces obtained according to (i.2) in at least two different streams, obtaining a first stream comprising one or more pieces of the catalyst coated membrane, said one or more pieces being depleted in sub-gasket, and a second stream comprising the sub-gaskets.

18. The process of claim 3, wherein (i) comprises
(i.1) providing a catalyst coated membrane assembly comprising a catalyst coated membrane and sub-gaskets;
(i.2) cutting the catalyst coated membrane assembly into pieces;
(i.3) sorting the pieces obtained according to (i.2) in at least two different streams, obtaining a first stream comprising one or more pieces of the catalyst coated membrane, said one or more pieces being depleted in sub-gasket, and a second stream comprising the sub-gaskets.

19. The process of claim 2, wherein the leaching agent comprised in the first mixture used according to (ii) is selected from the group consisting of a Brønsted acid, a Brønsted base or a complexing agent; wherein the acid preferably is hydrochloric acid, sulfuric acid, nitric acid or an organic acid; wherein the base preferably is an alkali metal hydroxide, an alkaline earth metal hydroxide, an alkali metal carbonate, an alkaline earth metal carbonate or an alkaline earth metal oxide; wherein the complexing agent preferably is ammonia, a compound comprising one or more of an amino group and a thio group, a crown ether, an amino derivative crown ether, a thio derivative crown ether, a cyclophane, an amino derivative cyclophane and a thio derivative cyclophane; preferably wherein the leaching agent comprised in the first mixture used according to (ii) is a Brønsted acid or a Brønsted base, more preferably a Brønsted acid.

20. The process of claim 3, wherein the leaching agent comprised in the first mixture used according to (ii) is selected from the group consisting of a Brønsted acid, a Brønsted base or a complexing agent; wherein the acid preferably is hydrochloric acid, sulfuric acid, nitric acid or an organic acid; wherein the base preferably is an alkali metal hydroxide, an alkaline earth metal hydroxide, an alkali metal carbonate, an alkaline earth metal carbonate or an alkaline earth metal oxide; wherein the complexing agent preferably is ammonia, a compound comprising one or more of an amino group and a thio group, a crown ether, an amino derivative crown ether, a thio derivative crown ether, a cyclophane, an amino derivative cyclophane and a thio derivative cyclophane; preferably wherein the leaching agent comprised in the first mixture used according to (ii) is a Brønsted acid or a Brønsted base, more preferably a Brønsted acid.
